(19) United States
(12) Patent Application Publication
(10) Pub. No.: US 2026/0198473 A1
(43) Pub. Date: Jul. 16, 2026

(54) METHOD FOR THE DISINSECTIZATION OF DRY PRODUCTS, NOTABLY GRAINS, CEREALS, LEGUMES OR FRUIT, UNDER GAS, IN AN AUTOCLAVE BY CONTROLLING THE PRESSURE AND REDUCED-PRESSURE PHASES

(71) Applicant: L'Air Liquide, Société Anonyme pour I'Etude et I'Exploitation des Procédés Georges Claude, Paris (FR)

(72) Inventors: Franck COUSIN, Saint Brevin les Pins (FR); Pauline LE DRU, Beaucouzé (FR); Dominique IBARRA, Gif-sur-Yvette (FR)

(21) Appl. No.: 19/443,909

(22) Filed: Jan. 8, 2026

(30) Foreign Application Priority Data
Jan. 14, 2025 (FR) FR2500366

(51) Int. Cl. A01M 1/00

(52) U.S. Cl. CPC A01M 1/00

(57) ABSTRACT

A method for disinsectization of dry products comprising:
loading the product into an autoclave-type unit, autoclave No1, the autoclave No1 being at atmospheric pressure P1;
injecting a treatment gas into the autoclave No1 allowing the autoclave No1 to be pressurized with an aid of the treatment gas to a treatment pressure Pτ, which is maintained for a treatment period; and
performing an operation of depressurizing the autoclave No1 to atmospheric pressure;
   wherein the operation comprises: i) an exchange phase between the autoclave No1 which has just been used and which is at the treatment pressure P_{T} and an autoclave-type unit empty of gas, referred to as autoclave No2, and ii) a phase effecting a passage from an intermediate pressure to atmospheric pressure with a decay time ranging from 1 to 3 minutes, the intermediate pressure being in the range of 4 to 5 bar.

### CROSS REFERENCE TO RELATED APPLICATIONS

This application claims the benefit of priority under 35 U.S.C. § 119 (a) and (b) to French Patent Application No. FR2500366, filed Jan. 14, 2025, the entire contents of which are incorporated herein by reference.

### BACKGROUND

The present invention relates to the field of the disinsectization of dry products. The present invention is most particularly concerned with the case of grains, dry fruits, cereals, pulses (legumes) or herbs and spices, which are notoriously infested, and must be treated before they are marketed.

While methyl bromide is an insecticide that has been used for a long time in this industry, its dangers are now widely recognized, and its use is now (except for a few really justified exceptions) prohibited.

Other more environmentally friendly disinsectization techniques have thus emerged, among which mention may be made of the methods set out below.

It is specifically generally known that insects are resistant, but that certain conditions are necessary for their survival. Besides food (which they find in the dry product to be disinsectized), insects need oxygen, but at very low levels, since concentrations usually slightly greater than 2% are sufficient for them, provided that there is no toxic gas in the rest of the atmosphere. Similarly, the permissible temperature range for most species is between 10° C. and 40° C. with a permissible humidity typically between 30 and 95%.

These different conditions necessary for the survival of insects have therefore generated possibilities for combatting their proliferation in different food products in general.

Mention may be made of heat treatments: in general, without any other adverse conditions, the increase in temperature makes it possible to destroy insects. However, it may cause texture, taste or other changes in the product to be disinsectized, especially since the exposure time required is relatively long in the case of acceptable temperatures for the product, and conversely, the temperatures to be applied are too high in the case where the treatment time should be much shorter.

Gas treatments based on CO2 have also been proposed. The literature on this subject is very abundant. Some of these gas treatments are carried out at atmospheric pressure. Carbon dioxide at high concentrations (70 to 80%) allows treatment without negative consequences for the products. However, the long duration necessary for such a treatment allows it to be used only for products whose longevity is significant. Specifically, depending on the temperature, it will typically take between 7 and 12 days to finalize the operation. In addition, a humidity greater than 65% or the presence of dust can significantly lengthen this time (between 30% and 50%). This system is therefore in practice envisaged only for the disinsectization of grain silos where the storage period is in any case significant (often more than one year).

Other treatments also combine CO2 and vacuum: the use of carbon dioxide at very high concentrations (>95%) in an enclosure that is virtually under vacuum (<0.3 bar absolute) allows treatment times to be significantly reduced, even if they are still relatively long, typically a few tens of hours.

Lastly, other treatments combine CO2 and high pressure, pressures of 20 to 25 bar, or even 30 bar, are mentioned in the literature, for the disinsectization of products most often with high added value and/or whose shelf life does not allow a long-lasting treatment. Between loading, unloading and processing, the duration of a cycle is only a few hours, which is very advantageous.

The prior art of autoclaves can be illustrated with document DE-44 10 116, which describes a functioning in which the document proposes a discharging of the chamber followed by the admission of the treatment gas, at treatment pressure, and this is only if the residual oxygen content in the chamber (which is regularly measured) is no longer satisfactory as the steps of discharging and of pressurizing with the treatment gas are repeated.

And nevertheless, the use of autoclaves for the disinsectization of grains under gas (usually CO2 or nitrogen) is obliged to comply with contact times in order to obtain the expected mortality on all stages of insect development, notably on hidden forms (eggs and larvae) which are much more resistant. This has a direct impact on productivity and investment costs associated with the method (OpEx and CapEx).

Admittedly, in order to meet productivity requirements, it is known to combine two autoclaves, installed in parallel, in order to recover the fraction of gas remaining in the second autoclave by pressure equalization. After this equalization, the remaining fraction of gas is preferably eliminated by gas flushing and venting. This represents about 4 to 5 bar directly expelled to the atmosphere.

It is moreover known that since global warming is generating more nuisances related to insect populations, and regulations are tightening on the use of chemicals (not authorized for the organic sector), the volumes of products to be treated and their diversity will be increasingly large, and this requires adaptation of the methods.

### SUMMARY

As will be seen in more detail hereinafter, the present invention proposes optimizing the treatment time in an autoclave under gas (preferably CO2 or nitrogen or mixtures thereof, gases which are preferred here notably for their cost, even if other gases may be envisaged), and to do so by controlling the depressurization time (from a determined pressure typically close to, and preferably of, 5 bar to atmospheric pressure), in order to achieve optimal efficiency for, and despite, a shorter cycle time; irrespective of the stage of the insect pests: egg, larvae, or adults.

The efficiency of the method proposed here is specifically significantly advantageous in the case of depressurization from a chosen pressure, as has been said preferably approximately 5 bar, to atmospheric pressure, compared with a depressurization from 10 to 5 bar for example.

Specifically, it is to the credit of the present invention to have proposed conditions in which benefit is made of about 5 bar not expelled to the atmosphere and to have understood that a depressurization from 10 bar to 0 does not have any more effect on the pests than a depressurization from about 5 bar to 0 bar.

It is notably to the credit of the present invention to have understood the importance of depressurization and to have studied solutions so that this depressurization is simultaneously technically feasible, while allowing a reduction in the consumption of gas.

As will be seen later in the present application, according to one of the embodiments of the invention, in this control of a depressurization from a chosen pressure, preferably approximately 5 bar, to atmospheric pressure, two autoclaves are used, and exchanges are carried out between an autoclave empty of gas and the other autoclave which has just been used (therefore at a treatment pressure, treatment pressure for example approximately 20 bar). More specifically, a transfer of gas between the autoclave that has just been used, referred to as autoclave No1, and the autoclave empty of gas, referred to as autoclave No2, is carried out.

According to the invention, it is not necessarily desired to recycle all the gas from an autoclave, because the lower the pressure, the more expensive the operation is in terms of suction and compression of gas. It is therefore conceivable that it is advantageous to rapidly depressurize from an intermediate pressure of 4 to 5 bar for:
optimization of the consumption of gas;
optimization of the electricity required for compression;
effectiveness on the treated products;
reduction of the risk of explosion due to the suspension of grain dust or other dust;
reduction of wear on installation components that could occur in connection with high-speed gas abrasion.

The present invention thus relates to a method for the disinsectization of dry products, and notably cereals, pulses, legumes, or herbs or spices, according to which:
the product is loaded into an autoclave-type unit, referred to as autoclave No1,autoclave No1 being at atmospheric pressure P1;
a treatment gas is injected into autoclave No1 allowing autoclave No1 to be pressurized with the aid of said gas to a treatment pressure Pτ, which is maintained for a treatment period;
an operation of depressurizing autoclave No1 to atmospheric pressure is performed;
   characterized in that said operation of depressurizing autoclave No1 comprises: i) an exchange phase between autoclave No1 which has just been used and which is at the treatment pressure PT and an autoclave-type unit empty of gas, referred to as autoclave No2, and ii) a phase effecting the passage from an intermediate pressure to atmospheric pressure in a decay time ranging from 1 minute to 3 minutes, and preferably around 2 minutes, said intermediate pressure being in the range of 4 to 5 bar.

### BRIEF DESCRIPTION OF THE DRAWING

For a further understanding of the nature and objects for the present invention, reference should be made to the following detailed description, taken in conjunction with the accompanying drawings, in which like elements are given the same or analogous reference numbers and wherein:

FIG. 1 illustrates an example of a pressure curve implemented according to the present invention.

### DETAILED DESCRIPTION OF PREFERRED EMBODIMENTS

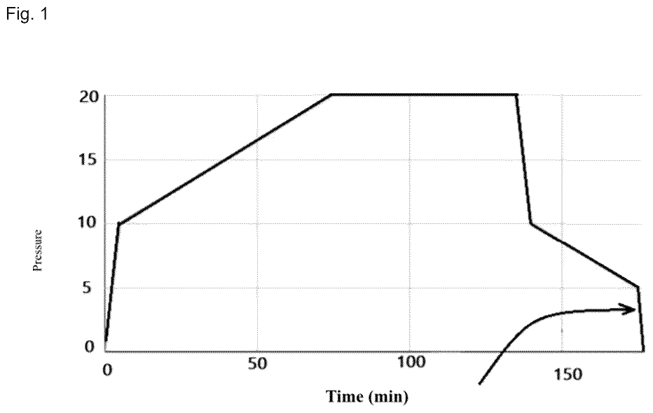

Appended FIG. 1 illustrates an example of a pressure curve implemented according to the invention (variation in pressure in bar as a function of the elapsed time in minutes), with the aid of two autoclaves, two autoclaves which are positioned in parallel and are both in fluidic communication with a source of treatment gas.

This curve clearly shows an increase in pressure to a pressure of approximately 10 bar, a treatment hold in the vicinity of 20 bar, a phase of allowing the pressure in autoclave No1 to drop from 20 bar to 10 bar, this drop being realized by equalization with autoclave No2; then a phase of depressurizing autoclave No1, in which the treatment took place, from 5 bar to atmospheric pressure (phase indicated by the large arrow), this last drop being realized in a few minutes.

In other words and in summary, according to one example of implementation of the invention:
the first increase to reach 10 bar corresponds to an equalization between autoclave No1 and autoclave No2: autoclave No1 is empty of gas, autoclave No2 is full. About 20 bar prevails in autoclave No2 which is full after completion in this autoclave No2 of a prior treatment of products;
after equalization between the two autoclaves, the two autoclave-type units are therefore brought back to 10 bar;
then in order to pass autoclave No1, which has to treat a load, from 10 to 15 bar, use is made of the storage reservoir for gas, for example CO2, which is at least at 18 bar, offering a “free” pressure source;
whereas in order to pass this same autoclave No1 from 15 to 20 bar, use is for example made of a compressor (booster) which sucks in gas from autoclave No2 which is at 10 bar. Autoclave No1, which has to treat a load, will therefore be increased to 20 bar, while autoclave No2 will be lowered from 10 to 5 bar.

According to one of the embodiments of the invention, there are therefore two autoclaves No1 and No2, positioned in parallel, and both in fluidic communication with a source of a treatment gas, and the following measures are implemented:
the product to be treated is loaded into autoclave No1, this autoclave being at atmospheric pressure P1;
treatment gas is injected into autoclave No1 allowing autoclave No1 to be pressurized with the aid of said gas to a pressure P2, P2 being lower than Pτ, the injection for reaching P2 being realized by equalizing autoclave No1 and autoclave No2, autoclave No2 being full at a pressure equal to or approximately P_{T} as a result of the realization of a previous treatment of products in this autoclave No2, the two autoclaves both being brought back to the pressure P2 after this equalizing operation;
autoclave No1 is passed from the pressure P2 to the pressure P_{T} by implementing one or other of the following methods:
   i) the additional injection of gas from said storage reservoir allowing autoclave No1 to pass from the pressure P2 to the pressure PT; or else
   j) autoclave No1 is passed from the pressure P2 to a pressure P3 lower than the pressure PT by performing the additional injection of gas from said storage reservoir; and then in order to pass autoclave No1, which has to treat a load, from P3 to PT, a compression means (compressor, booster) which sucks in gas from autoclave No2 which is at the pressure P2 is used, the pressure in autoclave No2 thus being brought back to around said intermediate pressure in the range of 4 to 5 bar;
this treatment pressure PT in autoclave No1 is maintained for a treatment period;
at the end of said treatment period, said operation of depressurizing autoclave No1 to atmospheric pressure is performed.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for disinsectization of dry products, the method comprising the steps of:
loading the product into an autoclave-type unit, referred to as autoclave No1,the autoclave No1 being at atmospheric pressure P1;
injecting a treatment gas into the autoclave No1 allowing the autoclave No1 to be pressurized with an aid of the treatment gas to a treatment pressure Pτ, which is maintained for a treatment period; and
performing an operation of depressurizing the autoclave No1 to atmospheric pressure;
wherein the step of performing the operation of depressurizing the autoclave No1 comprises: i) an exchange phase between the autoclave No1 which has just been used and which is at the treatment pressure PT and an autoclave-type unit empty of gas, referred to as autoclave No2, and ii) a phase effecting a passage from an intermediate pressure to atmospheric pressure with a decay time ranging from 1 minute to 3 minutes, the intermediate pressure being in the range of 4 to 5 bar.

2. The method of claim 1, wherein the two autoclaves No1 and No2, positioned in parallel, are both in fluidic communication with a storage reservoir for the treatment gas, and the following measures are implemented:
loading the product to be treated into the autoclave No1;
injecting the treatment gas into the autoclave No1 allowing the autoclave No1to be pressurized with the aid of the treatment gas to a pressure P2, P2 being lower than P_{T}, the injection for reaching P2 being realized by equalizing the autoclave No1 and the autoclave No2, the autoclave No2 being full at a pressure equal to or approximately P_{T} as a result of the realization of a previous treatment of the products in the autoclave No2, the two autoclaves both being brought back to the pressure P2 after this equalizing operation;
passing the autoclave No1 from the pressure P2 to the pressure P_{T} by implementing one or other of the following methods:
i) an additional injection of gas from the storage reservoir allowing the autoclave No1 to pass from the pressure P2 to the pressure P_{T}; or
ii) the autoclave No1 is passed from the pressure P2 to a pressure P3lower than the pressure P_{T} by performing an additional injection of gas from the storage reservoir, and then in order to pass the autoclave No1, which has to treat a load, from P3 to P_{T}, a compression means, which sucks in gas from the autoclave No2 which is at the pressure P2, is used, the pressure in the autoclave No2 thus being brought back to around the intermediate pressure in the range of 4 to 5 bar;
maintaining the treatment pressure PT in the autoclave No1 for the treatment period; and
performing, at the end of the treatment period, the operation of depressurizing the autoclave No1 to atmospheric pressure, which depressurization comprises a phase effecting the passage from the intermediate pressure, in the range of 4 to 5 bar, to atmospheric pressure, with the decay time ranging from 1 minute to 3 minutes.

3. The method of claim 1, wherein the dry products are cereals, pulses, legumes, herbs or spices.

4. The method of claim 1, wherein the decay time is around 2 minutes.

5. The method of claim 2, wherein the decay time is around 2 minutes.

6. The method of claim 2, wherein the compression means is a compressor, or a booster.
